(19) United States
(12) Patent Application Publication
(10) Pub. No.: US 2018/0248598 A1
(43) Pub. Date: Aug. 30, 2018

(54) SCALABLE LINEARLY POLARIZED PHASED ARRAY ANTENNAS AND METHODS

(71) Applicant: TAOGLAS GROUP HOLDINGS LIMITED, Enniscorthy (IE)

(72) Inventor: Sifiso GAMBAHAYA, Wexford (IE)

(21) Appl. No.: 15/906,321

(22) Filed: Feb. 27, 2018

Related U.S. Application Data
(60) Provisional application No. 62/463,855, filed on Feb. 27, 2017.

(51) Int. Cl. H04B 7/04; H04B 7/06; H01Q 21/22; H01Q 3/40

(52) U.S. Cl. CPC H04B 7/0469; H01Q 3/40; H01Q 21/22; H04B 7/0617

(57) ABSTRACT

5G-ready antennas and methods are disclosed. The 5G antennas have the ability to incorporate analog/digital beamforming. The antennas can scale-up in array size to realize massive multiple-input, multiple output (MIMO) scenarios to provide robust communications capability and support ever-increasing bandwidth requirements.

### CROSS-REFERENCE

This application claims the benefit of U.S. Provisional Application No. 62/463,855, filed Feb. 27, 2017, entitled 71-76 GHZ SCALABLE LINEARLY POLARIZED PHASED ARRAY ANTENNA, which application is incorporated herein by reference.

### BACKGROUND

### Field

The present disclosure relates in general to an antenna and, in particular, to a phased-array antenna.

### Background

With deployment expected to begin circa 2020, 5th generation (5G) wireless networks will support 1,000-fold gains in capacity, connections for at least 100 billion devices, and a 10 GB/s individual user experience capable of extremely low latency and response times. The 71-76 GHz band is has been approved worldwide for ultra-high capacity point-to-point communications. This band represents by far the most ever allocated at any one time at millimeter wavelength (mmW), enabling data rates that cannot be achieved at the bandwidth-limited lower microwave frequency bands. Radio access that takes advantage of this imminent spectrum will be built upon both new radio access technologies and evolved existing wireless technologies.

What are needed are 5G-ready antennas that have the ability to incorporate analog/digital beamforming and that can scale-up in array size to realize massive multiple-input, multiple output (MIMO) scenarios to provide robust communications capability and support ever-increasing bandwidth requirements.

### SUMMARY

The disclosed 5G antennas and methods have the ability to incorporate analog/digital beamforming. The antennas can scale-up in array size to realize massive multiple-input, multiple output (MIMO) scenarios to provide robust communications capability and support ever-increasing bandwidth requirements.

An aspect of the disclosure is directed to scalable linearly polarized phased array antenna systems, Suitable antenna systems comprise: an antenna body having an antenna body first side and an antenna body second side further comprising a first antenna plate having a length and a width, a plurality of first antenna channels positioned on an interior surface of the first antenna plate, and a plurality of perimeter apertures; a second antenna plate having a length and a width, a plurality of second antenna channels on an interior surface of the second antenna plate, and a plurality of interior apertures wherein the second antenna plate interior surfaces faces the first antenna plate interior surface; an I/O waveguide positioned adjacent the antenna body first side; and a plurality of transmitters positioned adjacent the antenna body second side. In at least some configurations, a plurality of fastening apertures and/or a plurality of antenna body apertures can be provided. The plurality of first antenna channels can be configurable to face the plurality of second antenna channels when the first antenna plate and the second antenna plate are positioned in the planar facing arrangement. Additionally, the perimeter apertures can be positioned adjacent the outer end of the plurality of first antenna channels and the outer end of the plurality of second antenna channels. The interior apertures can be positioned adjacent the inner end of the plurality of first antenna channels and the inner end of the plurality of second antenna channels.

Another aspect of the disclosure is directed to scalable linearly polarized phased array antennas. Suitable antennas comprise: an antenna body having an antenna body first side and an antenna body second side further comprising a first antenna plate having a length and a width, a plurality of first antenna channels positioned on an interior surface of the first antenna plate, and a plurality of perimeter apertures; and a second antenna plate having a length and a width, a plurality of second antenna channels on an interior surface of the second antenna plate, and a plurality of interior apertures wherein the second antenna plate interior surfaces faces the first antenna plate interior surface. The antennas are further configurable to comprise a plurality of fastening apertures and/or a plurality of antenna body apertures. The plurality of first antenna channels can be configurable to face the plurality of second antenna channels when the first antenna plate and the second antenna plate are positioned in the planar facing arrangement. In some configurations, the perimeter apertures are positionable adjacent the outer end of the plurality of first antenna channels and the outer end of the plurality of second antenna channels. In some configurations, the interior apertures are positionable adjacent the inner end of the plurality of first antenna channels and the inner end of the plurality of second antenna channels Additionally, the antennas are configurable to incorporate at least one of analog beamforming and digital beamforming.

Still another aspect of the disclosure is directed to scalable linearly polarized phased array antenna systems. Suitable antenna systems comprise: an antenna body having an antenna body first side and an antenna body second side further a plurality of antenna channels therein wherein each antenna channel is in communication with a perimeter aperture at a first end of the antenna channel and an interior aperture a second end of the antenna channel; an I/O waveguide positioned adjacent the antenna body first side; and a plurality of transmitters positioned adjacent the antenna body second side. The systems can additionally comprise a plurality of fastening apertures and/or a plurality of antenna body apertures.

Yet another aspect of the disclosure is directed to scalable linearly polarized phased array antennas. Suitable antennas comprise: an antenna body having an antenna body first side and an antenna body second side further a plurality of antenna channels therein wherein each antenna channel is in communication with a perimeter aperture at a first end of the antenna channel and an interior aperture a second end of the antenna channel. In at least some configurations, the antennas comprise a plurality of fastening apertures and/or a plurality of antenna body apertures.

### INCORPORATION BY REFERENCE

All publications, patents, and patent applications mentioned in this specification are herein incorporated by reference to the same extent as if each individual publication, patent, or patent application was specifically and individually indicated to be incorporated by reference:
______. 71-76 GHz Millimeter-wave Transceiver System Data Sheet, Revision 1.2 © 2014-2015;
AL-NUAIMI, et al. “Design of High-Directivity Compact-Size Conical Horn Lens Antenna,” IEEE Antennas and Wireless Propagation Letters, Vol. 13 pp. 467-470 (Jan. 6, 2014) available from http://ieeexplore.ieee.org/stamp/stamp.jsp?tp=&arnumber=6701338;
BORYSSENKO, et al. “Substrate free G-band Vivaldi Antenna Array Design, Fabrication and Testing,” 39th International Conference on Infrared, Millimeter and Terahertz Waves (September 14-19, 2014);
ORDEK, et all. “Horn Array Antenna Design for Ku-Band Applications” Electrical and Electronics Engineering, 2015 9th International Conference (Nov. 26-28, 2015), pp. 351-354 available from http://www.emo.org.tr/ekler/560de9154bd7576_ek.pdf;
SAYEED, “The New mmW ‘Porcupine’ Channel Sounder from NI and AT&T is Missing Quills (Beams)!” published Apr. 15, 2017, available from https://www.linkedin.com/pulse/new-mmw-porcupine-channel-sounder-from-ni-att-missing-akbar-sayeed/; and
TOMURA, et al. “A 45 Linearly Polarized Hollow-Waveguide 16×16 Slot Array Antenna Covering 71-86 GHz Band,” IEEE Transactions on Antennas and Propagation, Vol. 62(10), October 2014.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is an isometric illustration of a transmitter system according to the disclosure;

FIG. 1B is an illustration of an antenna back plate according to the disclosure;

FIG. 1C is an illustration of an antenna front plate according to the disclosure;

FIG. 1D is an illustrates an isometric view of an i/o waveguide according to the disclosure;

FIG. 2 is a table of exemplar specification ranges for electrical, mechanical and environmental features of an antenna system according to the disclosure;

FIG. 3 is a plot of simulated return loss of an antenna system according to the disclosure;

FIG. 4 is a plot of measured return loss of an antenna element of antenna system according to the disclosure;

FIG. 5 is a plot of simulated voltage standing wave radio (VSWR) of an antenna system according to the disclosure;

FIG. 6 is a plot of the simulated total efficiency of an antenna system according to the disclosure;

FIG. 7 is a plot of the simulated peak gain of an antenna system according to the disclosure;

FIG. 8 is a plot of the simulated average gain of an antenna system according to the disclosure;

FIG. 9 is a plot of simulated antenna-to-antenna coupling of an antenna system according to the disclosure;

FIG. 10 is a plot of measured antenna-to-antenna coupling of an antenna system according to the disclosure;

FIG. 11 is a plot of simulated x-z plane co-polarization of an antenna array according to the disclosure;

FIG. 12 is a plot of simulated x-z plane co-polarization with an applied phase shift of an antenna array according to the disclosure;

FIG. 13 is a plot of simulated x-y plane co-polarization of an antenna array according to the disclosure;

FIG. 14 is a plot of simulated x-y plane co-polarization with an applied phase shift of an antenna array according to the disclosure;

FIG. 15 is a plot of simulated x-y plane cross-polarization with an applied phase shift of an antenna array according to the disclosure;

FIG. 16 is a plot of simulated y-z plane cross-polarization of an antenna array according to the disclosure;

FIG. 17 is a three-dimensional plot of simulated radiation pattern of an antenna element of antenna system according to the disclosure;

FIG. 18 is a three-dimensional plot of simulated radiation pattern with an applied phase shift of an antenna array according to the disclosure;

FIG. 19 is a three-dimensional plot of simulated radiation pattern with an applied phase shift of an antenna array according to the disclosure; and

FIG. 20 is a three-dimensional plot of simulated radiation pattern with an applied phase shift of an antenna array according to the disclosure.

### DETAILED DESCRIPTION

Disclosed are 5G waveguide array antennas with, for example, 2×2 E band and four I/O ports suitable for analog/digital beamforming. The disclosed 5G waveguide array antennas are scalable to realize Massive MIMO communications. Scaling the disclosed antennas can be achieved by, for example, adjusting the feed network to accommodate more antennas. Thus, for example, up to 128 antennas could be accommodated with 64 of the antennas used for transmitting and 64 antennas used for receiving. Each antenna is configuration to have its own separate radio for MU-Massive MIMO. In some configurations, a sub-group of antennas can serve as user equipment (UE) and several UE can be supported simultaneously.

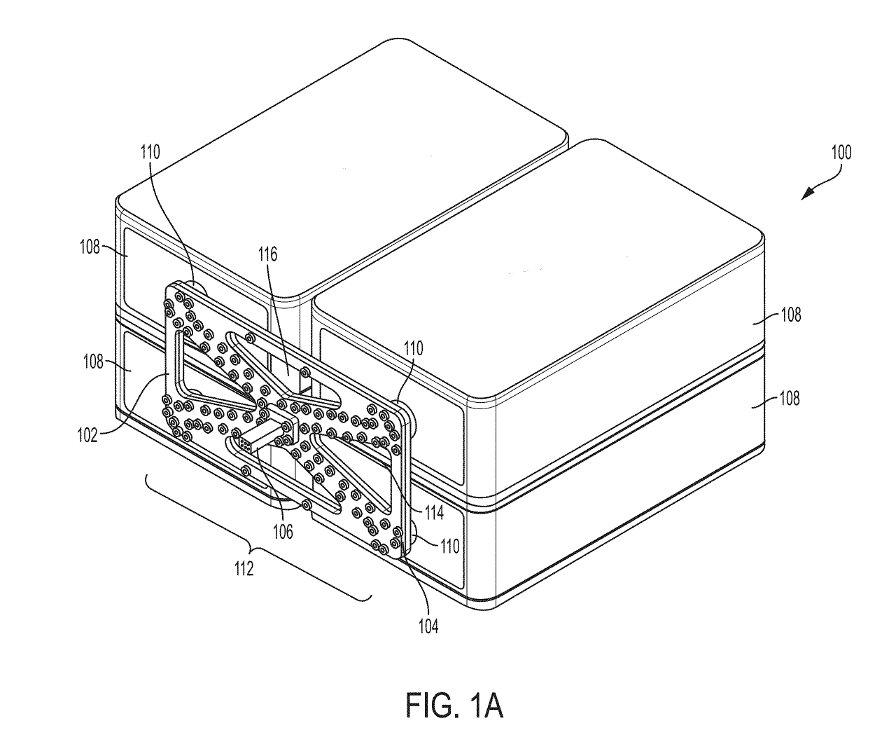

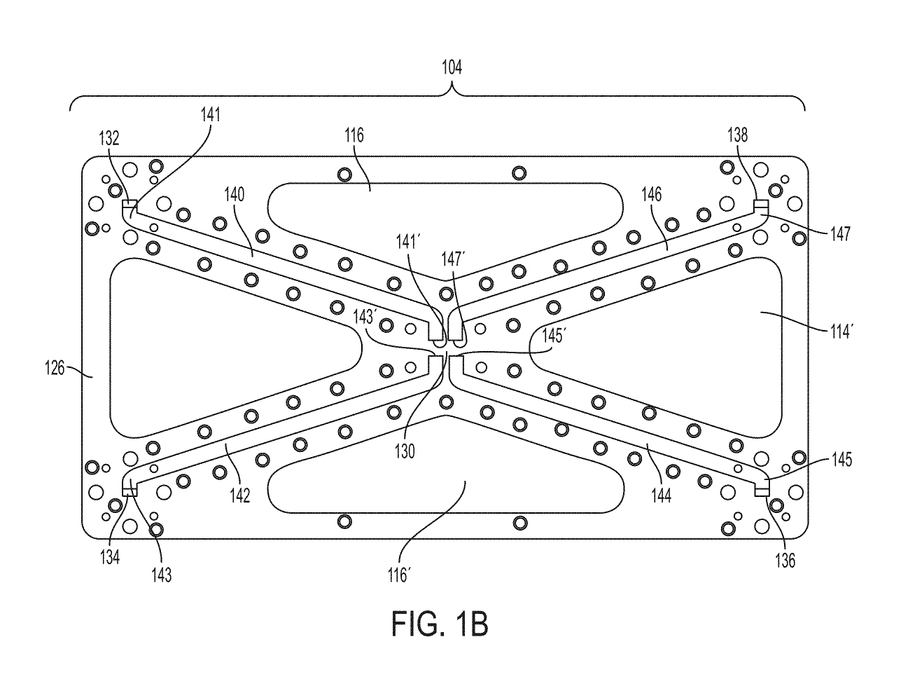

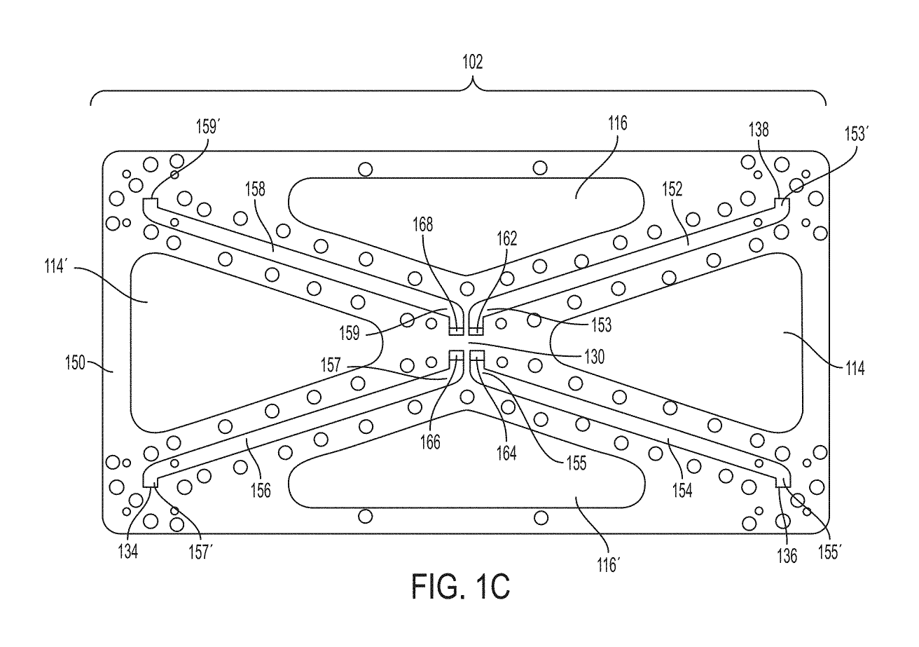

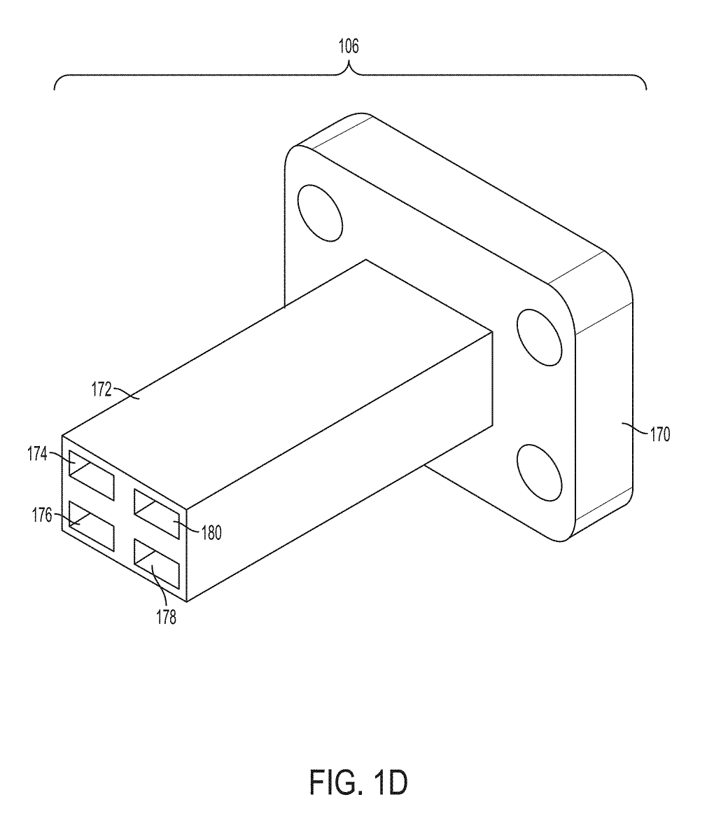

FIG. 1A is an isometric illustration of an antenna assembly 100 according to the disclosure. The antenna assembly 100 comprises, for example, an antenna front plate 102 and antenna back plate 104, which are positioned together to form an antenna body 112. Each of the antenna front plate 102 and the antenna back plate 104 have a plurality of antenna body apertures 114, 114′, 116, 116′ which line-up when the antenna front plate 102 and the antenna back plate 104 are placed adjacent one another (e.g., stacked). Two of the antenna body apertures can be used for transmission and two for receiving. More antennas can be used to increase directivity to the order of 20 dBi since the path lost at E-band is very high.

The antenna front plate 102 and the antenna back plate 104 are substantially planar and positioned in a stacked configuration (e.g., with the antenna front plate 102 adjacent the antenna back plate 104). An I/O waveguide 106 extending from the center of the antenna front plate 102 from a surface of the antenna body 112 which is opposite the surface of the antenna body 112 engaging the transmitters 108. The I/O waveguide 106 can be a UG 387/U compliant waveguide. Four mmW head transmitters 108, with waveguide ports 110. Suitable transmitters include, for example, National Instruments 3647 with WR-12 waveguide ports, available from National Instruments, Austin Tex.

FIG. 1B illustrates a planar view of a back plate interior facing surface 126 of the antenna back plate 104 which is positioned closest to the transmitters 108. The antenna back plate 104 is formed from a suitable conductive metal. In the embodiment depicted, antenna back plate 104 is formed from brass. As will be appreciated by those skilled in the art, other materials can be used for the back plate without departing from the scope of the disclosure. The antenna back plate 104 can have a uniform thickness. The perimeter of the antenna back plate 104, as illustrated, is rectangular with rounded corners. Inside the perimeter of the antenna back plate 104, there are four antenna body apertures 114, 114′, 116, 116′ which are triangular with rounded corners, positioned such that the shape of antenna back plate 104 is that of an “X” surrounded by a box. Other shapes can be employed. However, the waveguides will typically be straight to avoid introducing discontinuities which might negatively impact antenna impedance.

Near each corner of the antenna back plate 104 are back plate perimeter apertures 132, 134, 136, 138 which mate with a corresponding waveguide port 110 of the respective mating mmW head transmitter 108. The shape of the back plate perimeter apertures is shaped to Numbered counterclockwise when viewed from the back the perimeter apertures, beginning in the top left corner are: first back plate perimeter antenna aperture 132, second back plate perimeter antenna aperture 134, third perimeter antenna aperture 136, and fourth perimeter antenna aperture 138. The back plate perimeter antenna apertures 132, 134, 135, 138 are positioned to engage the wave guide ports 110 on the exterior surface of the antenna back plate 104. The size and shape of the back plate perimeter antenna apertures are standard waveguide sizes per MTh standards. The size is typically determined by the lower cutoff frequency for the TE10 mode.

From each perimeter aperture proceeding to the center of the “X” are four waveguide antenna channels having a first end at the perimeter of the antenna back plate 104 and a second end near the center of the antenna back plate 104. As will be appreciated by those skilled in the art, the number of channels is based on performance. For example, more waveguide antenna channels could be increased depending on the RF channels of the transceiver. A first back plate antenna channel 140 proceeds from a first end 141 near the first back plate perimeter antenna aperture 132 towards a second end 141′ near the center 130 of the antenna back plate 104; a second back plate antenna channel 142 proceeds from a first end 143 near the second back plate perimeter antenna aperture 134 to a second end 143′ near the center 130 of the antenna back plate 104; a third back plate antenna channel 144 proceeds from a first end 145 near a third perimeter antenna aperture 136 to a second end 145′ near the center 130 of the antenna back plate 104; and a fourth back plate antenna channel 146 proceeds from a first end 147 near a fourth perimeter antenna aperture 138 to a second end 147′ near the center 130 of the antenna back plate 104. Each waveguide channel is distinct; at no point do the waveguide channels intersect. As will be appreciated by those skilled in the art, the waveguide channels can be configured to intersect if, for example, a power splitter/combiner is used to merge the 4 RF paths. In addition, the antenna back plate 104 contains a plurality of fastening apertures of circular cross-section: 71 fastening apertures for fastening the antenna back plate 104 to antenna front plate 102, 16 fastening apertures for fastening the antenna body 112 to each WR-12 waveguide port 110 of the respective mating mmW head transmitter 108, and 4 fastening apertures for attaching the I/O waveguide 106. Suitable fasteners for use with the fastening apertures include, for example, screw, nut-and-bolt, rivet, etc. Any suitable fastener aperture shape can be used without departing from the scope of the disclosure.

FIG. 1C illustrates of a front plate interior facing surface 150 of the antenna front plate 102. The interior facing surface of the front plate 102 is positioned facing the interior facing surface of the back plate 104. The antenna front plate 102 is also formed from a suitable conductive metal. In the embodiment depicted, antenna front plate 102 is formed from brass; other embodiments may employ different materials. The antenna front plate 102 is planar and of uniform thickness with a front plate interior surface 150. The perimeter of antenna front plate 102 is a rectangle with rounded corners having a size and shape that substantially mirrors the size and shape of the antenna back panel 102 in at least two dimensions. Inside the perimeter, there are four triangular apertures with rounded corners, positioned such that the shape of antenna front plate 102 is that of an “X” surrounded by a box. The four triangular apertures substantially mirror the triangular apertures of the back plate 104.

The front plate 102 mates with back plate 104 to form the antenna body 112 (shown in FIG. 1A). Near the center of the “X” in antenna front plate 102 are apertures which mate with the waveguide channels 174, 176, 178, 189 of the I/O waveguide 106. Numbered clockwise when viewed from the back, beginning in the center right are first interior antenna waveguide aperture 162, second interior antenna waveguide aperture 164, third interior antenna waveguide aperture 166, and fourth interior antenna waveguide aperture 168. From each aperture proceeding to the corners of the antenna front plate 102 are four waveguide channels which mirror the waveguide channels on the back plate 104. A first front plate antenna channel 152 proceeds from a first end 153 near the first interior antenna waveguide aperture 162 to a second end 153′ near the perimeter of the antenna front plate 102; a second front plate antenna channel 154 proceeds from a first end 155 near a second interior antenna waveguide aperture 164 to a second end 155′ near the perimeter of the antenna front plate 102; a third front plate antenna channel 156 proceeds from a first end 157 near a third interior antenna waveguide aperture 166 to a second end 157′ near the perimeter of the antenna front plate 102; and a fourth front plate antenna channel 158 proceeds from a first end 159 near a fourth interior antenna waveguide aperture 168 to a second end 159′ near the perimeter of the antenna front plate 102. Each channel is distinct; at no point do channels intersect. In addition, antenna front plate 102 contains a plurality of apertures of circular cross section: 71 apertures for fastening the antenna front plate 102 to antenna back plate 104, 16 apertures for fastening the antenna body 112 to each WR-12 waveguide port 110 of the respective mating mmW head transmitter 108, and 4 apertures for attaching the I/O waveguide 106. Suitable fasteners include, for example, screw, nut-and-bolt, rivet, etc.

FIG. 1D is an isometric view of I/O waveguide 106. I/O waveguide 106 is formed from a suitable conductive metal. In the embodiment depicted, I/O waveguide 106 is formed from brass; other embodiments may employ different materials. I/O waveguide 106 comprises a base 170 and a central column 172 of rectangular cross-section. Base 170 contains four apertures for attachment to antenna body 112 (FIG. 1A). Suitable means of attachment include screw, nut-and-bolt, rivet, etc. Central column 172 contains four waveguide channels. Numbered counterclockwise from top left are first antenna waveguide channel 174, second antenna waveguide channel 176, third antenna waveguide channel 178, and fourth antenna waveguide channel 180. First antenna waveguide channel 174 mates with first interior antenna waveguide aperture 162 of antenna front plate 102; Second antenna waveguide channel 176 mates with second interior antenna waveguide aperture 164 of antenna front plate 102; third antenna waveguide channel 178 mates with third interior antenna waveguide aperture 166 of antenna front plate 102; and fourth antenna waveguide channel 180 mates with fourth interior antenna waveguide aperture 168 of antenna front plate 102. Thus, a separate waveguide path is created for each antenna, from the corresponding mmW head transmitter 108, through antenna body 112, to I/O waveguide 106 where it may be connected to external components, electronics assemblies, etc.

When the antenna assembly 100 is configured, each one of the four I/O waveguides 108 engage a corner of the antenna body 112, so that each waveguide port 110 communicates with a back plate perimeter aperture 134, 134, 136, 138 of the antenna body 112. Each back plate perimeter aperture 134, 134, 136, 138 communicates with one of the four conduits formed by each of pair of facing channels in the antenna front plate 102 and the antenna back plate 104 when the plates are placed together (e.g., first back plate antenna channel 140 facing first front plate antenna channel 152, when the interior surface of the back plate 104 is positioned against the interior surface of the front plate 102, etc.). The four conduits are then in communication with one of the interior antenna waveguide apertures 162, 164, 166, 168. One of each of the four interior antenna waveguide apertures 162, 164, 166, 168 is then in communication with one of the four waveguide channels 174, 176, 178, 180 of the central column 172 of the I/O waveguide 106.

In order to scale the configuration, two additional transmitters can be plated next to the four so that there is a dual “x” configuration. Additional design changes such as more wave feeds for the transceiver that has additional ports can be used to scale while keeping the same architecture.

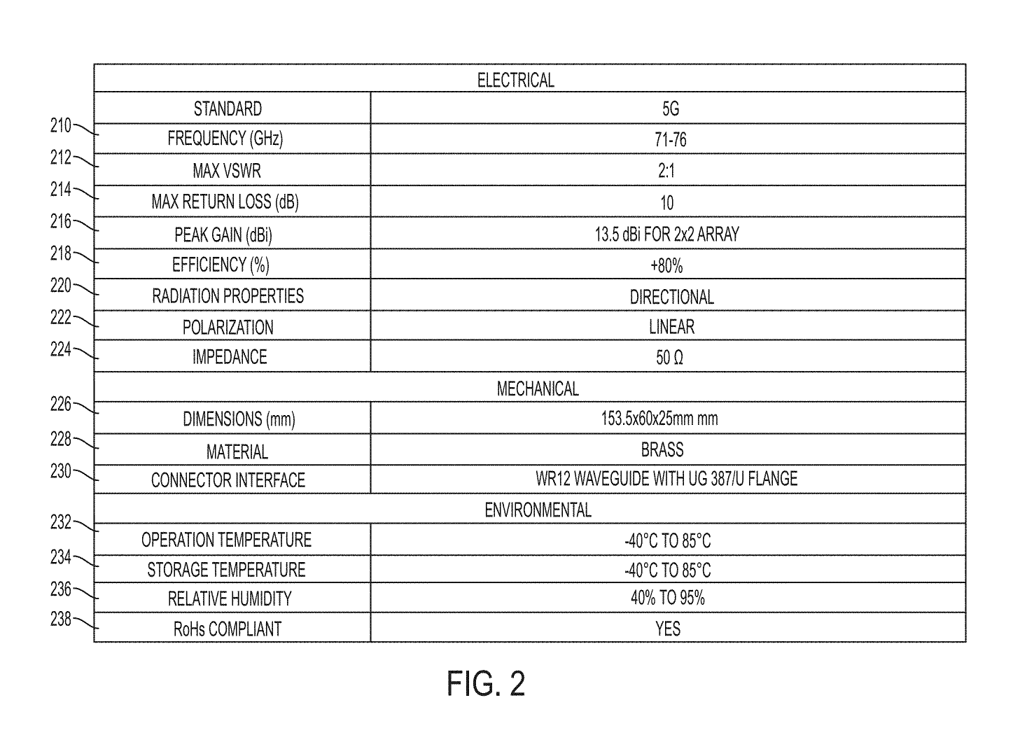

FIG. 2 lists, in tabular format, exemplar specification ranges for radio frequency, mechanical features, and environmental parameters for a device according to the disclosure. Radio frequency specifications listed in the table include frequency band 210, maximum VSWR 212, maximum return loss 214, peak gain 216, efficiency 218, radiation properties 220, polarization 222, and impedance 224. Mechanical features defined in FIG. 2 include dimensions 226, material 228 and connector interface 230. Environmental parameters listed in FIG. 2 include operating temperature range 232, storage temperature range 234, relative humidity range 236, and Restriction of Hazardous Substances compliance 238.

To characterize performance of the disclosed devices, a number of simulations and experimental measurements were performed for a 2×2 antenna array with identical characteristics and specifications to the disclosure. In the simulations and experiments, elements were numbered antenna 1 through antenna 4, corresponding those described in FIGS. 1A-1D.

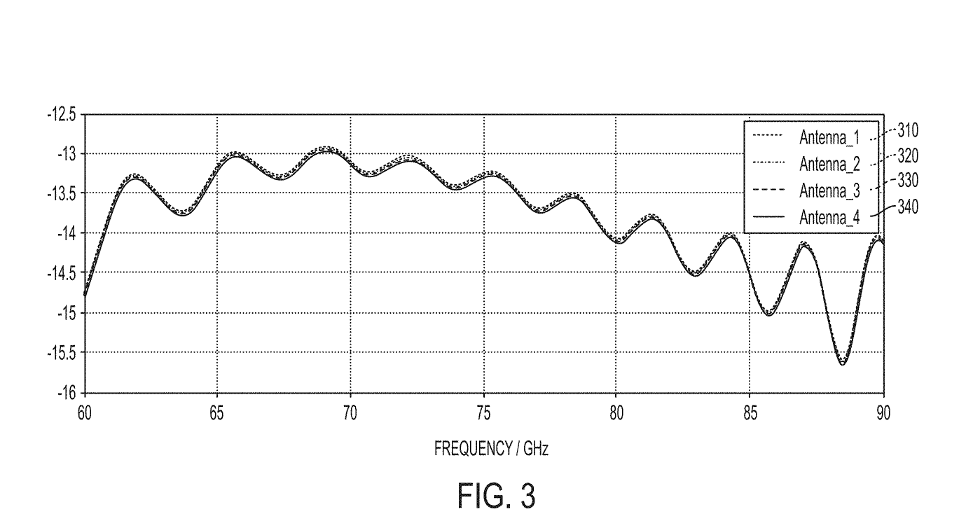

FIG. 3 is a plot of simulated return loss from 60 GHz to 90 GHz of an exemplar 2×2 antenna array that models return loss of the disclosed system. Traces on the plot represent results for antenna 1 simulated return loss 310, antenna 2 simulated return loss 320, antenna 3 simulated return loss 330, and antenna 4 simulated return loss 340. Note that in the region from 71 GHz to 76 GHz, the traces are almost identical, deviating from on another almost imperceptibly. In the region from 71 GHz to 76 GHz, the return loss varies in a sinusoidally-decreasing manner from a value of approximately −13.25 dB at 71 GHz to a value of approximately −14.0 dB at 76 GHz, reaching a maximum value of approximately −13.1 dB at approximately 71.8 GHz.

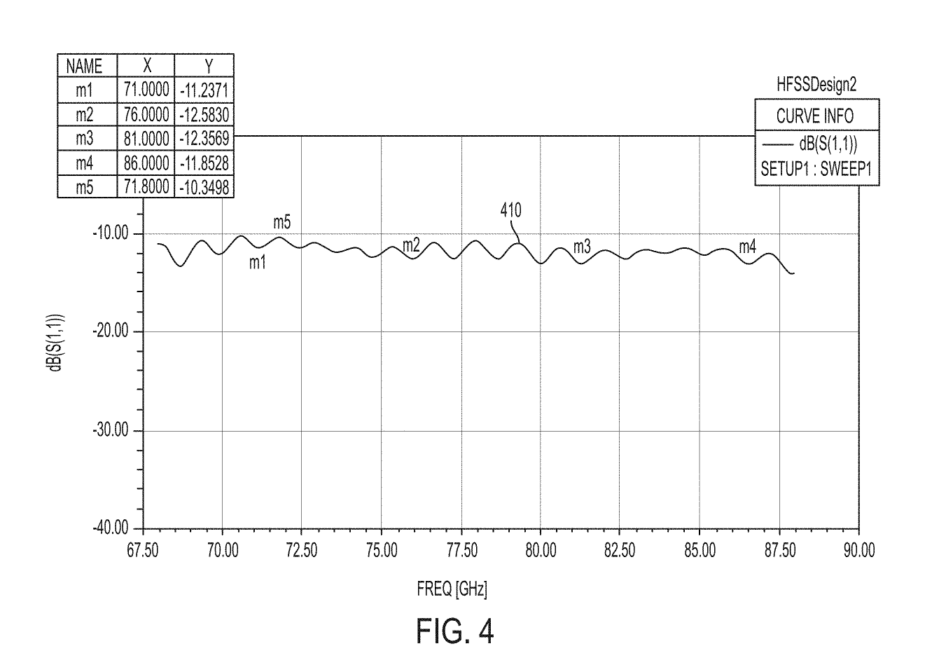

FIG. 4 is a plot of measured return loss from 67.5 GHz to 90 GHz of an antenna element of an antenna system according to the disclosure. The trace on the plot represents results for antenna 1 measured return loss 410. In the region from 71 GHz to 76 GHz, the return loss varies sinusoidally from a value of −11.24 dB at 71 GHz to a value of −12.58 dB at 76 GHz, reaching a maximum value of −10.35 dB at 71.8 GHz.

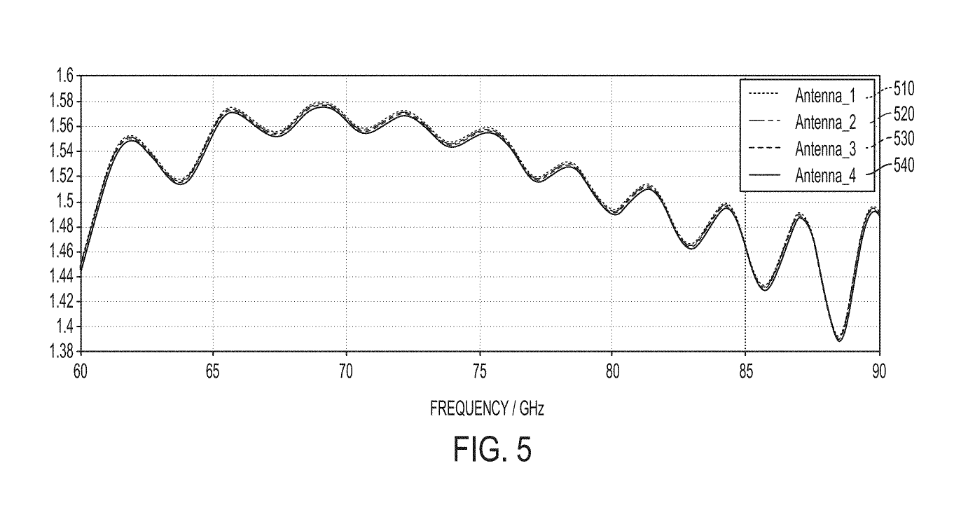

FIG. 5 is a plot of simulated VSWR from 60 GHz to 90 GHz of a 2×2 antenna array that models VSWR of the disclosed system. Traces on the plot represent results for antenna 1 VSWR 510, antenna 2 VSWR 520, antenna 3 VSWR 530, and antenna 4 VSWR 540. Note that the individual traces are so uniform as to be virtually indistinguishable. In the region from 71 GHz to 76 GHz, the return loss varies in a sinusoidally-decreasing manner from a value of approximately 1.55 at 71 GHz to a value of approximately 1.53 at 76 GHz, reaching a maximum value of approximately 1.57 dB at approximately 71.8 GHz.

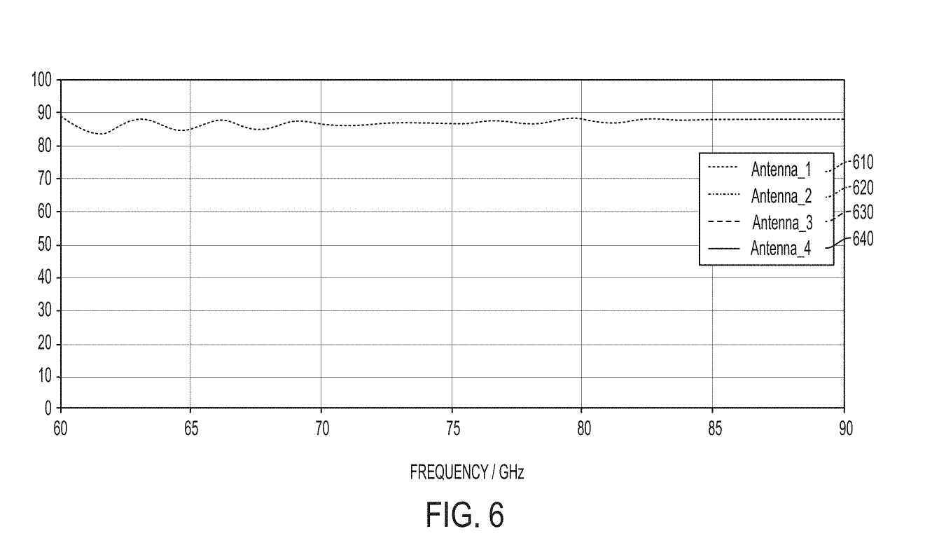

FIG. 6 is a plot of simulated total efficiency from 60 GHz to 90 GHz of a 2×2 antenna array that models total efficiency of the disclosed system. Traces on the plot represent results for antenna 1 total efficiency 610, antenna 2 total efficiency 620, antenna 3 total efficiency 630, and antenna 4 total efficiency 640. The individual traces are so uniform as to be indistinguishable. In the region from 71 GHz to 76 GHz, the total efficiency is virtually flat, varying between approximately 87% and 88%.

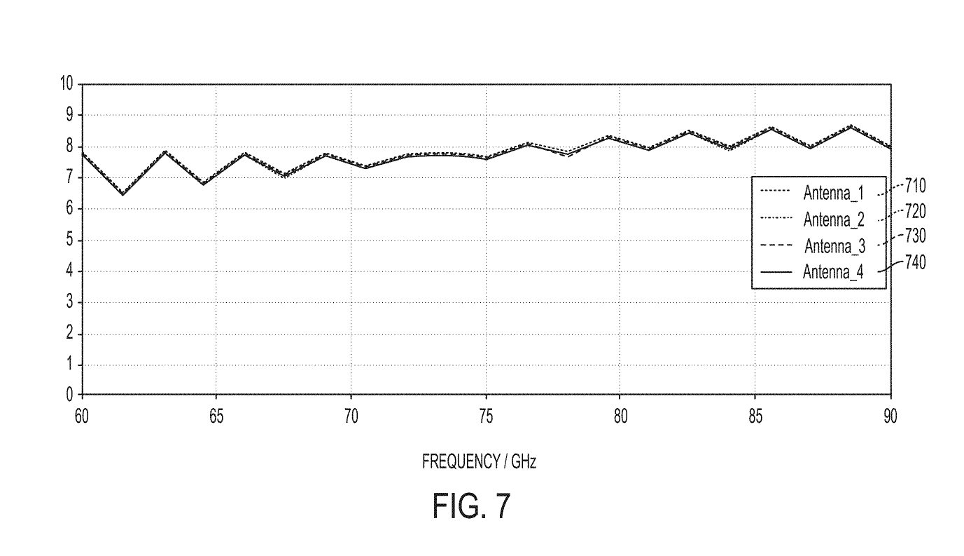

FIG. 7 is a plot of simulated 1D peak gain from 60 GHz to 90 GHz of a 2×2 antenna array that models peak gain of the disclosed system. Traces on the plot represent results for antenna 1 1D peak gain 710, antenna 2 1D peak gain 720, antenna 3 1D peak gain 730, and antenna 4 1D peak gain 740. The individual traces are so uniform as to be virtually indistinguishable. The 1D peak gain has a value of approximately 7.3 dB at 71 GHz and a value of approximately 7.8 dB at 76 GHz.

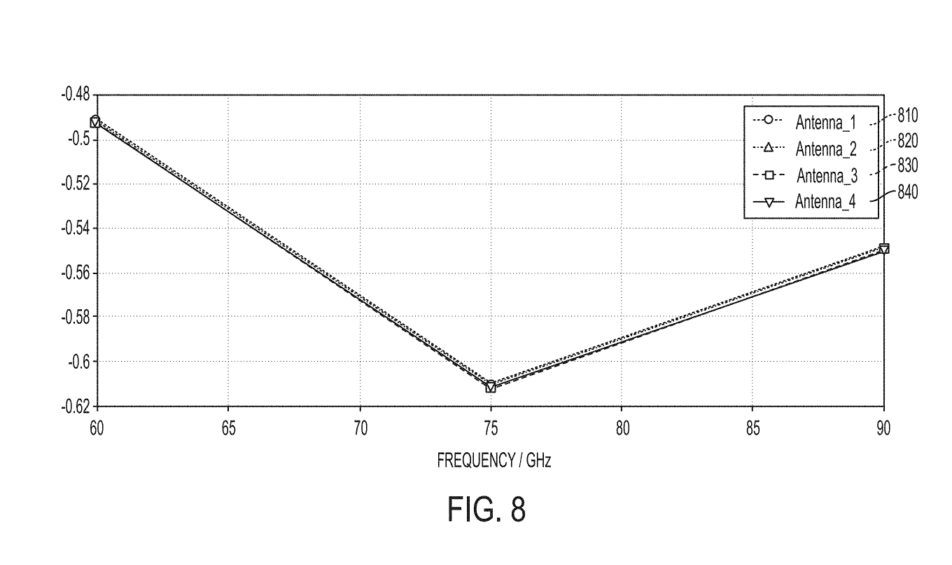

FIG. 8 is a plot of simulated 1D average gain from 60 GHz to 90 GHz of a 2×2 antenna array that models average gain of the disclosed system. Traces on the plot represent results for antenna 1 1D average gain 810, antenna 2 1D average gain 820, antenna 3 1D average gain 830, and antenna 4 1D average gain 840. The individual traces are so uniform as to be virtually indistinguishable. The 1D average gain has a value of approximately −0.58 dB at 71 GHz. It then decreases linearly to a value of approximately −0.61 dB, then rises linearly to a value of approximately −0.605 dB at 76 GHz.

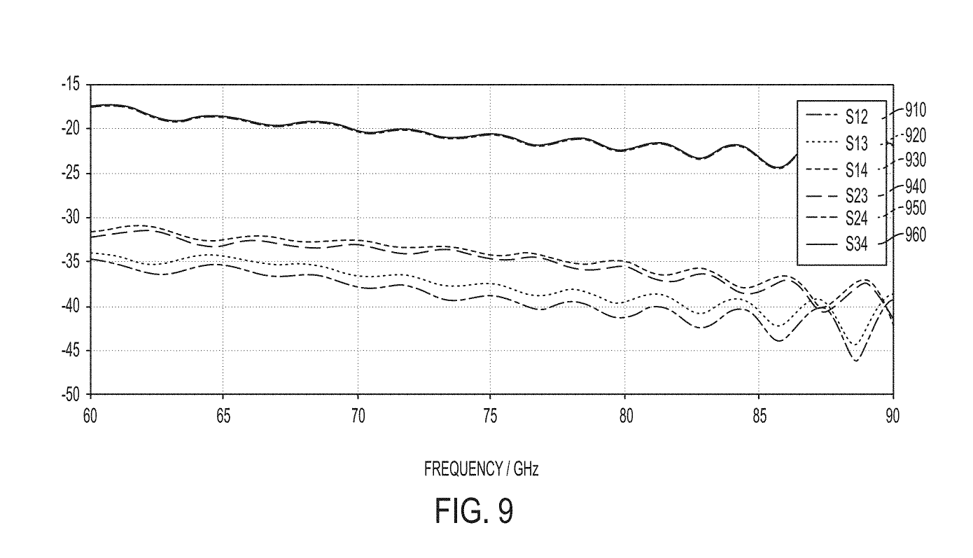

FIG. 9 is a plot of simulated antenna-to-antenna coupling from 60 GHz to 90 GHz of a 2×2 antenna array that models average gain of the disclosed system. Traces on the plot represent results for antenna 1/antenna 2 coupling 910, antenna 1/antenna 3 coupling 920, antenna 1/antenna 4 coupling 930, antenna 2/antenna 3 coupling 940, antenna 2/antenna 4 coupling 950, and antenna 3/antenna 4 coupling 960. The coupling results decrease sinusoidally across the entire plotted range. Antenna 1/antenna 3 coupling 920 and antenna 2/antenna 4 coupling 950 are greatest, followed by antenna 1/antenna 4 coupling 930 and antenna 2/antenna 3 coupling 940, followed by antenna 1/antenna 2 coupling 910 and antenna 3/antenna 4 coupling 960, which exhibit the least coupling.

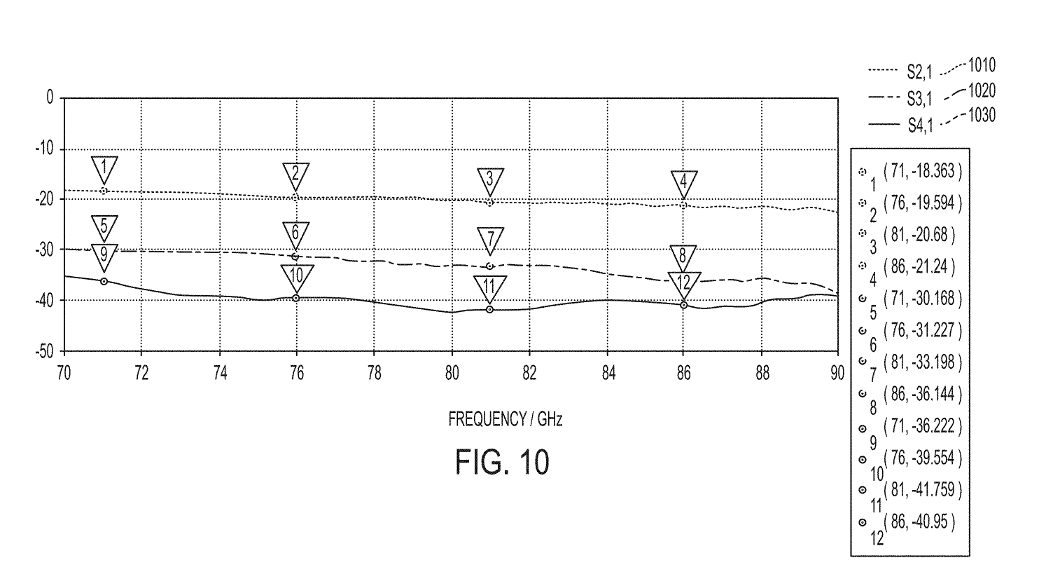

FIG. 10 is a plot of measured antenna-to-antenna coupling of an antenna system according to the disclosure. Traces on the plot represent results for measures antenna 1/antenna 2 coupling 1010, measured antenna 1/antenna 3 coupling 1020, and measured antenna 1/antenna 4 coupling 1030. Several points of interest are noted on the plot and tabulated.

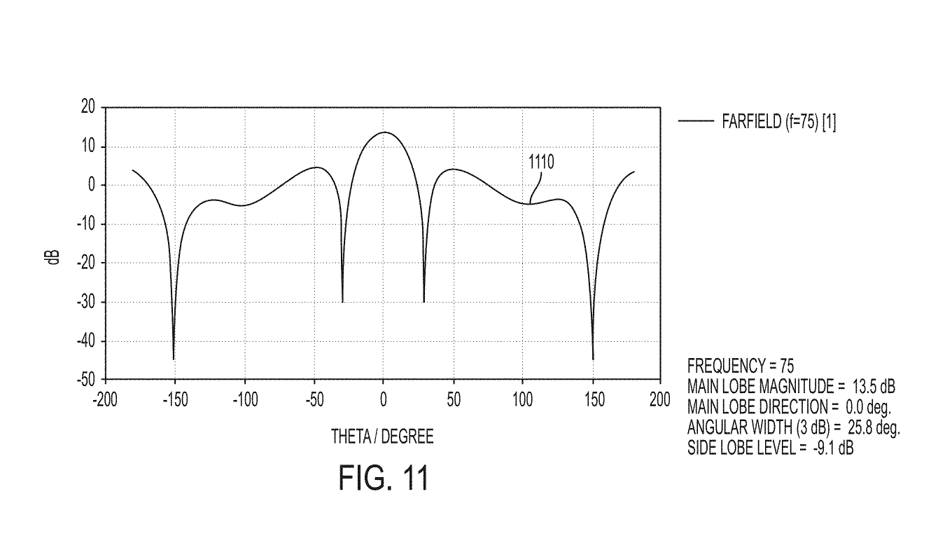

FIG. 11 is a 2D plot of simulated realized gain in the x-z plane at a frequency of 75 GHz for an antenna array that models realized gain of the disclosed system. The trace on the plot represents the simulated realized gain in the x-z plane 1110 measured in dB, plotted from −180 degrees to 180 degrees. The main lobe magnitude is 13.5 dB; main lobe direction is θ=0.0°; half-power beam width (HPBW) is 25.8°; and side lobe level is −9.1 dB.

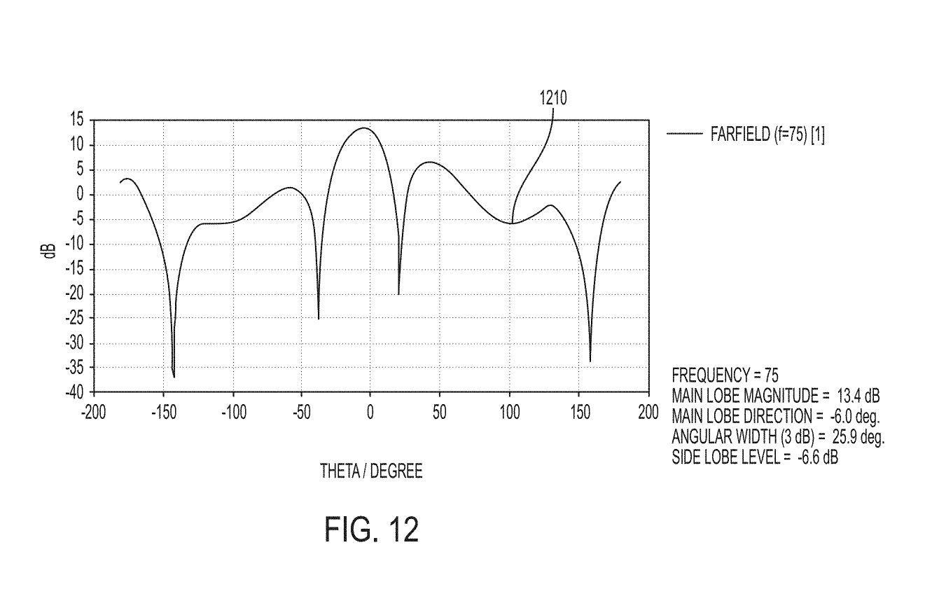

FIG. 12 is a 2D plot of simulated realized gain in the x-z plane at a frequency of 75 GHz with the main beam steered 45°, for an antenna array that models radiation pattern of the disclosed system. The trace on the plot represents results the simulated 45°-steered realized gain in the x-z plane 1210 measured in dB, plotted from −180° to 180°. The main lobe magnitude is 13.4 dB; main lobe direction is θ=−6.0°; HPBW is 25.9°; and side lobe level is −6.6 dB.

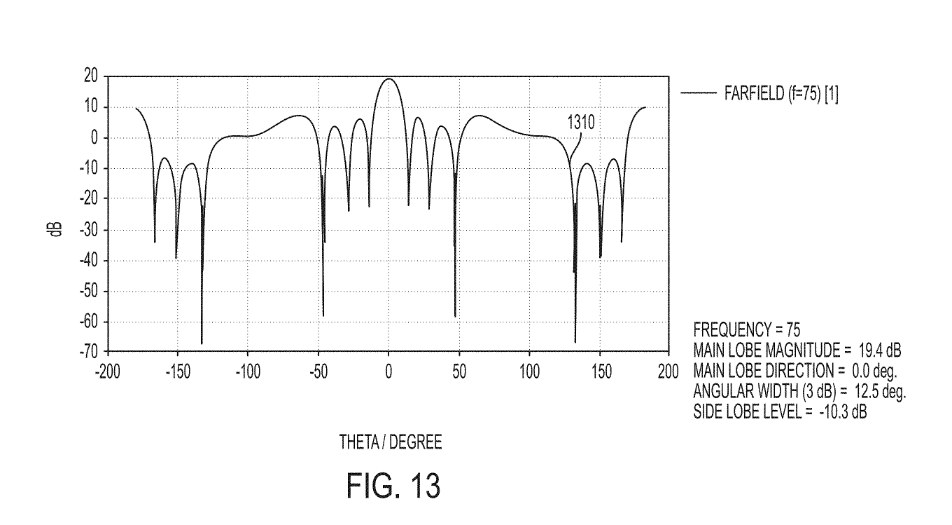

FIG. 13 is a 2D plot of simulated realized gain in the x-y plane at a frequency of 75 GHz, for an antenna array that models radiation pattern of the disclosed system. The trace on the plot represents results the simulated realized gain in the x-y plane 1310 measured in dB, plotted from −180° to 180°. The main lobe magnitude is 19.4 dB; main lobe direction is θ=0.0°; HPBW is 12.5°; and side lobe level is −10.3 dB.

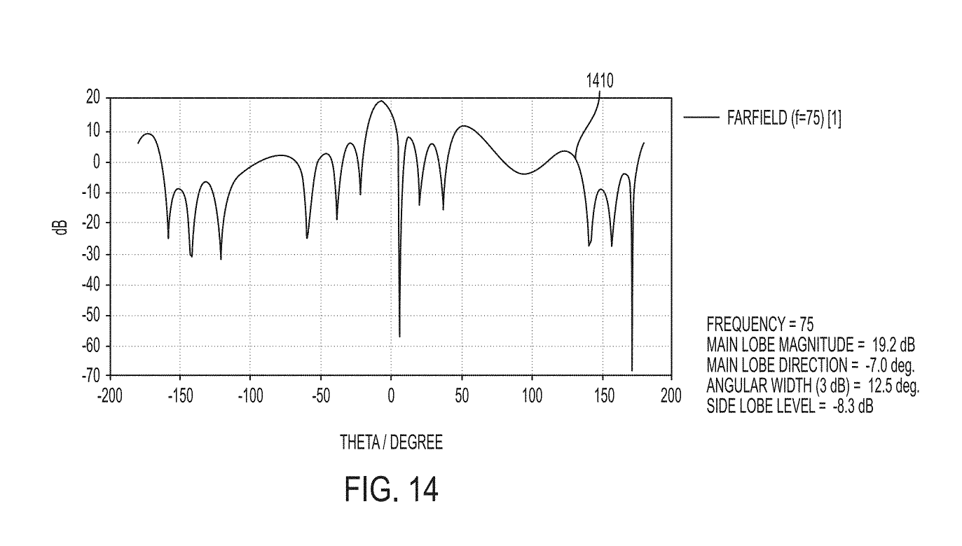

FIG. 14 is a 2D plot of simulated realized gain in the x-y plane at a frequency of 75 GHz with the main beam steered 45°, for an antenna array that models radiation pattern of the disclosed system. The trace on the plot represents results the simulated 45°-steered realized gain in the x-y plane 1410 measured in dB, plotted from −180° to 180°. The main lobe magnitude is 19.2 dB; main lobe direction is θ=−7.0°; HPBW is 12.5°; and side lobe level is −8.3 dB.

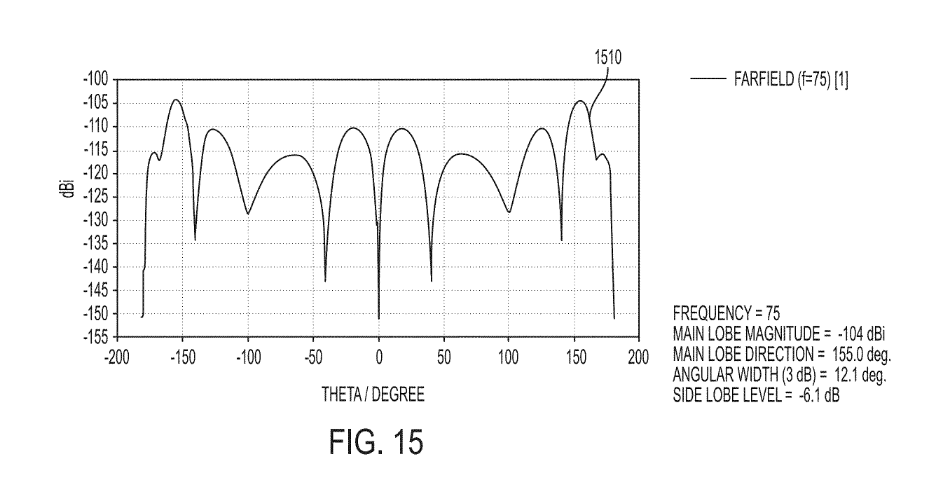

FIG. 15 is a 2D plot of simulated directivity in the x-y plane at a frequency of 75 GHz with the main beam steered 45°, for an antenna array that models radiation pattern of the disclosed system. The trace on the plot represents results the simulated 45°-steered directivity in the x-y plane 1510 measured in dB, plotted from −180° to 180°. The main lobe magnitude is −104 dBi; main lobe direction is θ=155.0°; HPBW is 12.1°; and side lobe level is −6.1 dB.

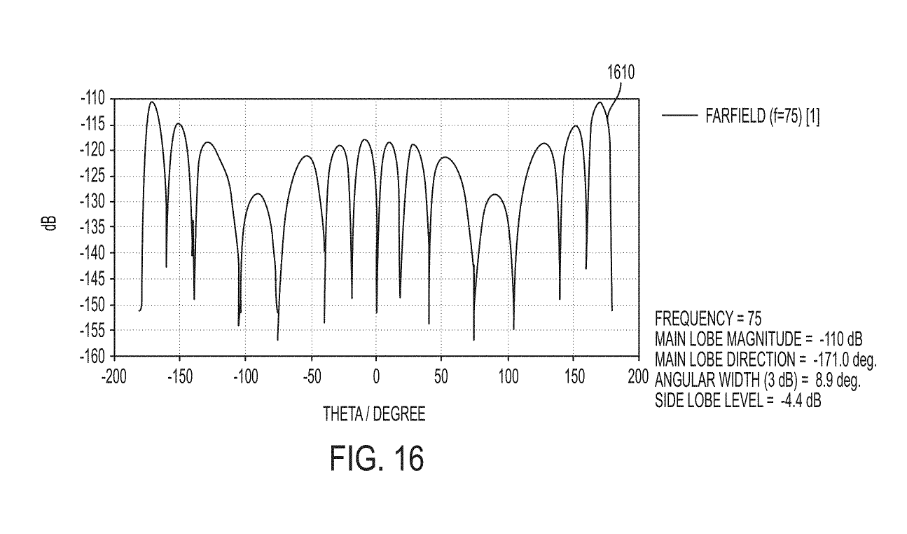

FIG. 16 is a 2D plot of simulated realized gain in the y-z plane at a frequency of 75 GHz, for an antenna array that models radiation pattern of the disclosed system. The trace on the plot represents results the simulated realized gain in the y-z plane 1610 measured in dB, plotted from −180° to 180°. The main lobe magnitude is −110 dB; main lobe direction is θ=−171.0°; HPBW is 8.9°; and side lobe level is −4.4 dB.

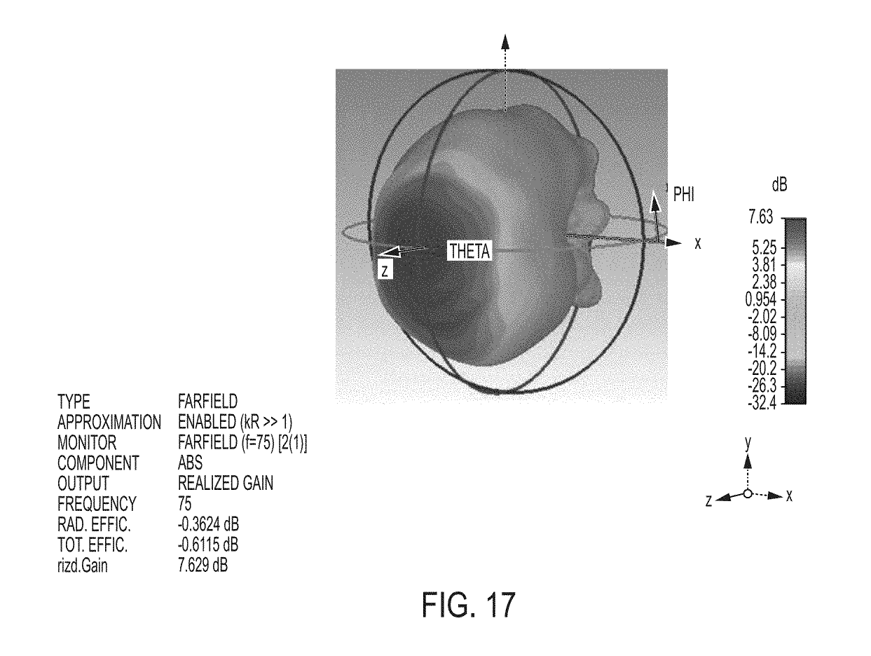

FIG. 17 is a 3D plot of the radiation pattern at a frequency of 75 GHz and HPBW of 80°, for an antenna element that models the radiation pattern of a single antenna element of the disclosed system. Maximum realized gain is 7.63 dB; radiation efficiency is −0.362 dB; and total efficiency is −0.612 dB.

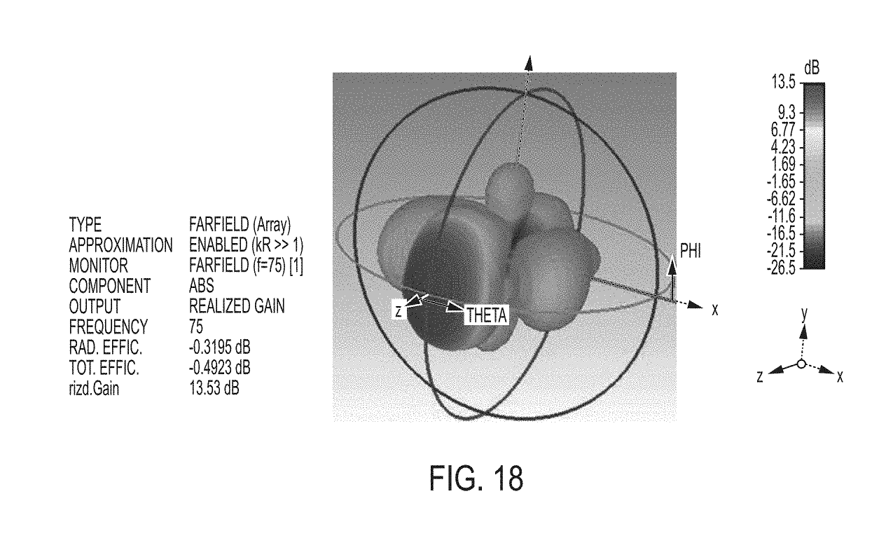

FIG. 18 is a 3D plot of the radiation pattern at a frequency of 75 GHz with the main beam steered 45° and HPBW of 25°, for an antenna array that models the radiation pattern of the disclosed system. Maximum realized gain is 13.5 dB; radiation efficiency is −0.320 dB; and total efficiency is −0.492 dB.

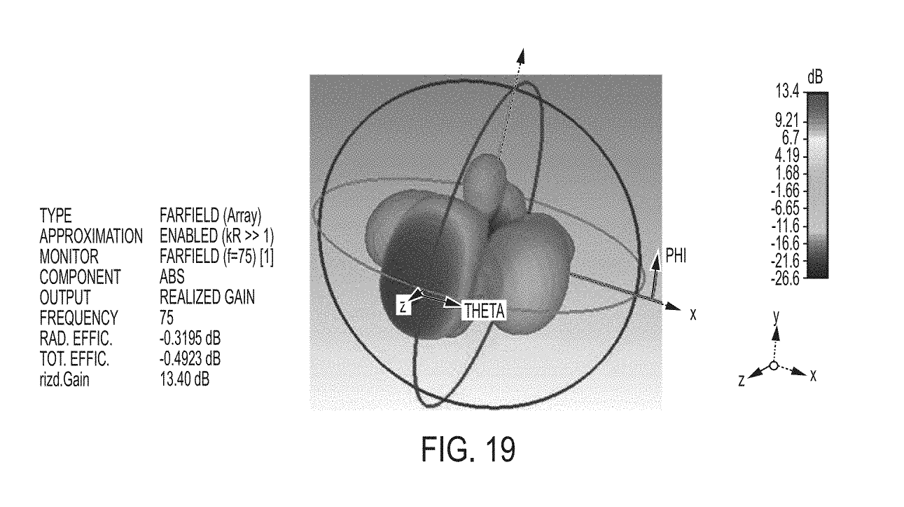

FIG. 19 is a 3D plot of the radiation pattern at a frequency of 75 GHz with the main beam steered 45° and HPBW of 26°, for an antenna array that models the radiation pattern of the disclosed system. Maximum realized gain is 13.4 dB; radiation efficiency is −0.320 dB; and total efficiency is −0.492 dB.

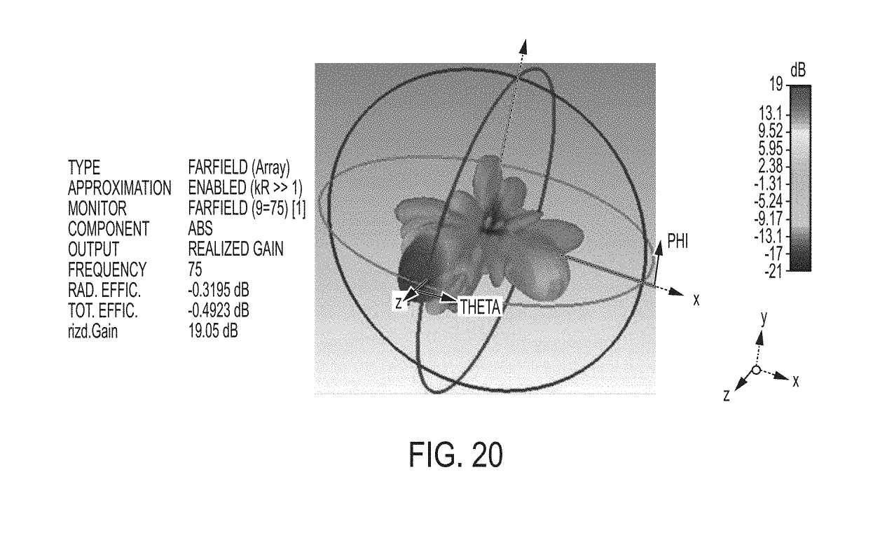

FIG. 20 is a 3D plot of the radiation pattern at a frequency of 75 GHz with the main beam steered 45° with HPBW of 12.5°, for an antenna array that models the radiation pattern of the disclosed system. Maximum realized gain is 19.05 dB; radiation efficiency is −0.320 dB; and total efficiency is −0.492 dB.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A scalable linearly polarized phased array antenna system comprising:
an antenna body having an antenna body first side and an antenna body second side further comprising
a first antenna plate having a length and a width, a plurality of first antenna channels positioned on an interior surface of the first antenna plate, and a plurality of perimeter apertures;
a second antenna plate having a length and a width, a plurality of second antenna channels on an interior surface of the second antenna plate, and a plurality of interior apertures wherein the second antenna plate interior surfaces faces the first antenna plate interior surface;
an I/O waveguide positioned adjacent the antenna body first side; and
a plurality of transmitters positioned adjacent the antenna body second side.

2. The scalable linearly polarized phased array antenna system of claim 1 further comprising a plurality of fastening apertures.

3. The scalable linearly polarized phased array antenna system of claim 1 further comprising a plurality of antenna body apertures.

4. The scalable linearly polarized phased array antenna system of claim 1 wherein the plurality of first antenna channels faces the plurality of second antenna channels when the first antenna plate and the second antenna plate are positioned in the planar facing arrangement.

5. The scalable linearly polarized phased array antenna system of claim 1 wherein the perimeter apertures are adjacent the outer end of the plurality of first antenna channels and the outer end of the plurality of second antenna channels.

6. The scalable linearly polarized phased array antenna system of claim 1 wherein the interior apertures are adjacent the inner end of the plurality of first antenna channels and the inner end of the plurality of second antenna channels.

7. A scalable linearly polarized phased array antenna comprising:
an antenna body having an antenna body first side and an antenna body second side further comprising
a first antenna plate having a length and a width, a plurality of first antenna channels positioned on an interior surface of the first antenna plate, and a plurality of perimeter apertures; and
a second antenna plate having a length and a width, a plurality of second antenna channels on an interior surface of the second antenna plate, and a plurality of interior apertures wherein the second antenna plate interior surfaces faces the first antenna plate interior surface.

8. The scalable linearly polarized phased array antenna of claim 7 further comprising a plurality of fastening apertures.

9. The scalable linearly polarized phased array antenna of claim 7 further comprising a plurality of antenna body apertures.

10. The scalable linearly polarized phased array antenna of claim 7 wherein the plurality of first antenna channels faces the plurality of second antenna channels when the first antenna plate and the second antenna plate are positioned in the planar facing arrangement.

11. The scalable linearly polarized phased array antenna of claim 7 wherein the perimeter apertures are adjacent the outer end of the plurality of first antenna channels and the outer end of the plurality of second antenna channels.

12. The scalable linearly polarized phased array antenna of claim 7 wherein the interior apertures are adjacent the inner end of the plurality of first antenna channels and the inner end of the plurality of second antenna channels.

13. The scalable linearly polarized phased array antenna of claim 7 wherein the antenna is configurable to incorporate at least one of analog beamforming and digital beamforming.

14. A scalable linearly polarized phased array antenna system comprising:
an antenna body having an antenna body first side and an antenna body second side further a plurality of antenna channels therein wherein each antenna channel is in communication with a perimeter aperture at a first end of the antenna channel and an interior aperture a second end of the antenna channel;
an I/O waveguide positioned adjacent the antenna body first side; and
a plurality of transmitters positioned adjacent the antenna body second side.

15. The scalable linearly polarized phased array antenna system of claim 14 further comprising a plurality of fastening apertures.

16. The scalable linearly polarized phased array antenna system of claim 14 further comprising a plurality of antenna body apertures.

17. A scalable linearly polarized phased array antenna comprising:
an antenna body having an antenna body first side and an antenna body second side further a plurality of antenna channels therein wherein each antenna channel is in communication with a perimeter aperture at a first end of the antenna channel and an interior aperture a second end of the antenna channel.

18. The scalable linearly polarized phased array antenna of claim 17 further comprising a plurality of fastening apertures.

19. The scalable linearly polarized phased array antenna of claim 17 further comprising a plurality of antenna body apertures.
